(19) United States
(12) Patent Application Publication
(10) Pub. No.: US 2012/0331286 A1
(43) Pub. Date: Dec. 27, 2012

(54) APPARATUS AND METHOD FOR PROVIDING SERVICE TO HETEROGENEOUS SERVICE TERMINALS

(75) Inventors: Seok-Hoon CHOI, Seoul (KR); Bo-Gyeong KANG, Seoul (KR)

(73) Assignee: Samsung Electronics Co., Ltd., Suwon-si (KR)

(21) Appl. No.: 13/524,482

(22) Filed: Jun. 15, 2012

(30) Foreign Application Priority Data
Jun. 27, 2011 (KR) 10-2011-0062557

(51) Int. Cl. H04L 9/00

(52) U.S. Cl. 713/156

(57) ABSTRACT

An apparatus and method for providing a service to heterogeneous service terminals without modifying a security framework are provided, in which a gateway that controls a first service terminal transmits a right delegation request to a server in order to provide the service to a second service terminal as well, and upon receipt of a service right verification request from the second service terminal after receiving a right delegation certificate from the server, the gateway transmits a service right verification response including the right delegation certificate to the second service terminal.

### PRIORITY

This application claims priority under 35 U.S.C. §119(a) to a Korean Patent Application filed in the Korean Intellectual Property Office on Jun. 27, 2011 and assigned Serial No. 10-2011-0062557, the entire content of which is incorporated herein by reference.

### BACKGROUND OF THE INVENTION

1. Field of the Invention

The present invention relates to an apparatus and method for providing a service to a service terminal capable of short-range communication, and more particularly, to an apparatus and method for providing a service to heterogeneous service terminals without modifying a security framework between them.

2. Description of the Related Art Due in part to the soaring growth of Consumer Electronics (CE) devices capable of short-range communication, such as Motion Picture Experts' Group Audio Layer-3 (MP3) players, a Portable Multimedia Players (PMPs), game players, netbooks, etc., users seek more convenient methods for downloading content to be used in CE devices.

However, CE devices have very limited direct access to external networks. For example, some CE devices can access an external network, but only if the Internet is available to the devices by Wireless Fidelity (WiFi) in an area having an Access Point (AP). Therefore, there is a need for enabling CE devices, which cannot directly access an external network despite their capability of short-range communication, to receive an intended service, for example, to download content by accessing the external network through a gateway.

In a Converged Personal Network Service (CPNS), for example, a Personal Network (PN) is configured with a PN GateWay (PNGW) responsible for communication with an external network and a CE device that plays back an actual service and content. The CE device accesses a service/content provider in the external network through the PNGW, and thus provides a service or content. When using a CPNS, a CE device is referred to as a PN Entity (PNE).

Before a service is provided to individual PNEs, an authentication protocol is needed for the PNEs. The authentication protocol is implemented for communication entities to identify one another and precedes other subsequent protocols.

In case of a Universal Plug and Play (UPnP) network service, a controlled home network device (i.e., a Controlled Device (CD)) and a Control Point (CP) for controlling the CD form a home network, and the CD receives a service under the control of the CP.

To provide a requested service to devices capable of short-range communication as described above, a CP authenticates and manages a CD that is connected to a home network and controlled, without intervention of a server, in the UPnP network service.

However, in the CPNS, a CPNS server authenticates and manages a PNE corresponding to a CD and a PNGW functions as a relay for transmitting information about the PNE.

In this manner, a CP corresponding to a PNGW of the CPNS is responsible for authentication and management of a CD in a UPnP network, whereas a CPNS server is responsible for authentication and management of a PNE corresponding to a CD in the CPNS.

Accordingly, there exists a need for a method for freely sharing a service and content among various devices without intervention of a server in an environment that provides heterogeneous services including the above-described services. In addition, a method for authenticating CDs that provide heterogeneous services in an integrated manner is needed.

### SUMMARY OF THE INVENTION

An aspect of the present invention is to address at least the problems and/or disadvantages and to provide at least the advantages described below. Accordingly, an aspect of embodiments of the present invention is to provide an apparatus and method for providing a service to heterogeneous service terminals without modifying a security framework between them.

Another aspect of the present invention is to provide an apparatus and method for authenticating Controlled Devices (CDs) that provide heterogeneous services.

Further another aspect of the present invention is to provide an apparatus and method for sharing a service between devices that provide heterogeneous services, without intervention of a server.

In accordance with an aspect of the present invention, a system for providing a service to heterogeneous service terminals is provided. The system includes a first service terminal for configuring a Private Network (PN) with a GateWay (GW) and receiving a service from a server through the GW through short-range communication; the server in an external network, for providing the service to the GW; a second service terminal for sending a service right verification request to the GW through short-range communication; and the GW for providing the service received from the server to the first service terminal, and upon receiving the service right verification request from the second service terminal, determining whether the second service terminal is a heterogeneous service terminal supporting a different service from the service provided to the first service terminal, determining whether there is a right delegation certificate received from the server, which delegates a right for the second service terminal if the second service terminal is a heterogeneous service terminal, and transmitting a service right verification response including the delegated right delegation certificate to the second service terminal.

In accordance with another aspect of the present invention, a method for receiving a service from a server through a GW performed by a service terminal is provided. The method includes transmitting a service right verification request to the GW through short-range communication; receiving from the GW a service right verification response including a right delegation certificate and a signature generated by the GW, when the GW receives from the server the right delegation certificate that delegates a right for the service terminal to the GW in response to the service right verification request; verifying the received signature; and storing the received signature and the right delegation certificate, if the signature is verified as a valid signature.

In accordance with another aspect of the present invention, a gateway for providing a service to heterogeneous service terminals is provided. The gateway includes a short-range communication connector for establishing a physical connection with a first service terminal through short-range communication; a Personal Network (PN) configuration manager for configuring a PN upon receiving a PN connection request from the first service terminal; a service manager for receiving a service requested by the first service terminal from a Converged Personal Network Service (CPNS) server and transmitting the received service; a wireless access module for communicating with the CPNS server; a memory for storing information a service terminal with which the gateway has configured a PN; and a right delegation manager for, upon receiving a service right verification request from a second service terminal through the short-range communication connector, determining whether the second service terminal is a heterogeneous service terminal supporting a different service from the service provided to the first service terminal, determining whether there is a right delegation certificate received from the server, which delegates a right for the second service terminal if the second service terminal is a heterogeneous service terminal, and transmitting a service right verification response including the delegated right delegation certificate to the second service terminal.

### BRIEF DESCRIPTION OF THE DRAWINGS

The above and other objects, features and advantages of certain embodiments of the present invention will be more apparent from the following detailed description taken in conjunction with the accompanying drawings, in which:

FIG. 1 is a diagram illustrating a configuration of a Converged Personal Network Service (CPNS) system according to a comparative example according to an embodiment of the present invention;

FIG. 2 is a diagram illustrating a configuration of a CPNS system according to an embodiment of the present invention;

FIG. 3 is a block diagram illustrating a Personal Network GateWay (PNGW) according to an embodiment of the present invention;

FIG. 4 is a block diagram illustrating a service terminal according to an embodiment of the present invention;

FIG. 5 is a diagram illustrating a signal flow for an operation for delegating a right to a PNGW according to an embodiment of the present invention;

FIG. 6 is a diagram illustrating a right delegation certificate according to an embodiment of the present invention; and

FIG. 7 is a diagram illustrating an example of signature object information according to an embodiment of the present invention.

Throughout the drawings, the same drawing reference numerals will be understood to refer to the same elements, features and structures.

### DETAILED DESCRIPTION OF EMBODIMENTS OF THE PRESENT INVENTION

Reference will now be made in detail to the embodiments of the present invention with reference to the accompanying drawings. Like reference numerals denote the same components throughout the specification and the drawings. A detailed description of generally known functions and structures may be omitted where such a description may obscure the subject matter of the present invention.

While the names of entities as defined in Converged Personal Network Service (CPNS) of a standardization organization for applications of mobile terminals called the Open Mobile Alliance (OMA) are used for convenience in the following description, the standard and corresponding names are merely provided as examples and therefore do not limit the scope of the present invention. The present invention is also applicable to other such systems and standards having a similar technological background.

According to an embodiment of the present invention an apparatus and method for providing a service to heterogeneous service terminals without modifying a security framework between the terminals are provided. For this purpose, a GateWay (GW) that controls a first service terminal transmits a right delegation request to a server so that it can provide a service to a second service terminal as well as the first service terminal. After receiving a right delegation certificate from the server, if the PN receives a service right verification request from the second service terminal, the PN transmits a service right verification response including the right delegation certificate to the second service terminal. In this manner, the service terminals being Controlled Devices (CDs) can be authenticated without intervention of a server on the part of the GW, and the same service as the first service terminal receives can be received on the part of the second service terminal.

A Converged Personal Network Service (CPNS) that may be included heterogeneous services according to an embodiment of the present invention is described as follows.

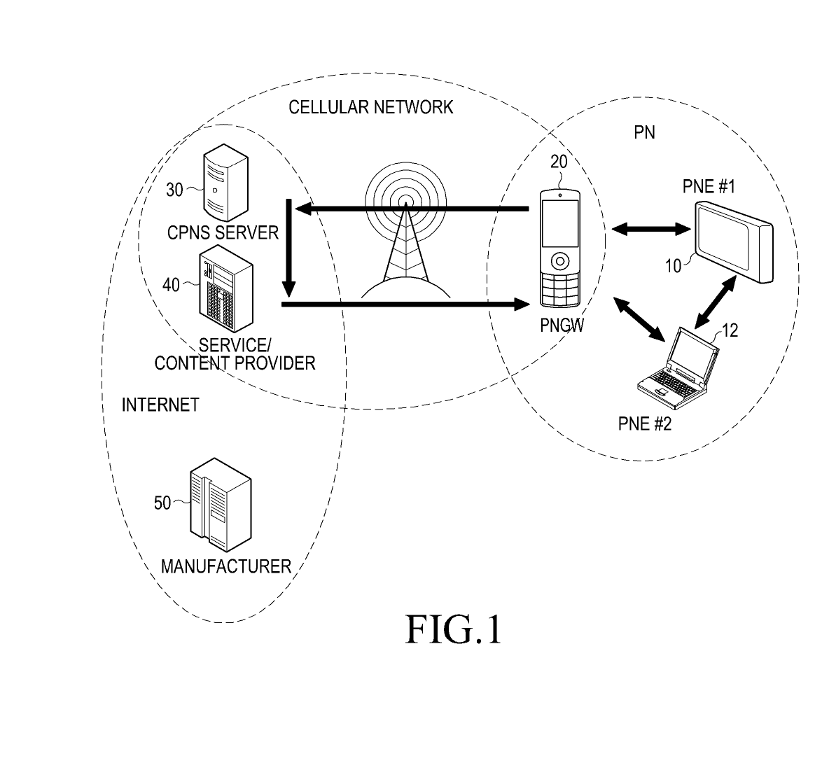

FIG. 1 is a diagram illustrating a configuration of a CPNS system according to a comparative example according to an embodiment of the present invention.

Referring to FIG. 1, the CPNS system largely includes at least one Personal Network Entity (PNE), such as PNEs 10 and 12, a Personal Network GateWay (PNGW) 20, a CPNS server 30, a service/content provider 40 serving as an application server, and a manufacturer (server) 50 that may be accessed over the Internet.

The PNEs 10 and 12 are service terminals that directly provide the CPNS. For example, the PNEs 10 and 12 may be MP3 players, Portable Multimedia Players (PMPs), game players, laptops, navigators, Customer Electronics (CE) devices such as a refrigerator, etc. These PNEs 10 and 12 provide a service to users by receiving user-requested content from the service/content provider 40 and playing back the received content.

Each of the PNEs 10 and 12 is equipped with a short-range communication module inside and is thus capable of short-range communication with a nearby PNE (i.e., another one of the PNE 10 or 12), but cannot directly access a service provider due to the absence of a communication module. Thus, the PNE 10 is paired with the PNGW 20 based on a short-range communication technology in order to transmit and receive data to and from the PNGW 20. Then the PNE 10 configures a PN with the PNGW 20. Thus, the PNE 10 may access the CPNS server 30 through the PNGW 20 and may receive content from the service/content provider 40 through the PNGW 20. In this manner, the PNE 10 can receive the CPNS.

The PNGW 20 relays the CPNS by authenticating and managing PNEs. Therefore, if a CD using a service other than the CPNS can receive the CPNS like a PNE, it is possible to freely provide a service and content to various devices.

For this purpose, embodiments of the present invention provide a method for allowing a second service terminal supporting a service heterogeneous from a service of a first service terminal to receive the same service of the first service terminal.

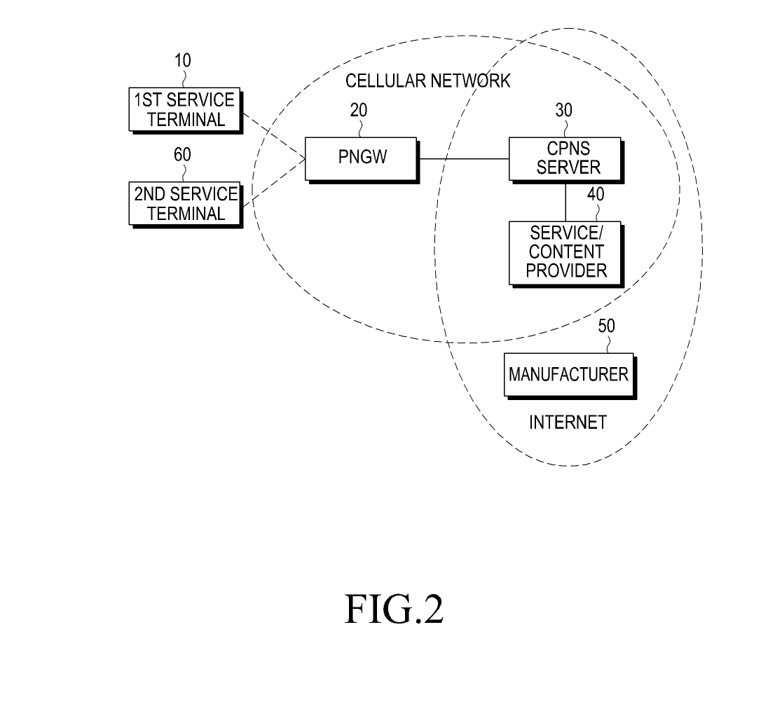

This method is described in detail as follows with reference to FIG. 2.

FIG. 2 is a diagram illustrating a configuration of a CPNS system according to an embodiment of the present invention. In FIG. 2, a first service terminal 10 is a PNE supporting the CPNS of FIG. 1 and a second service terminal 20 is a terminal supporting a service other than the CPNS (e.g., a Universal Plug and Play (UPnP) Digital Living Network Alliance (DLNA) terminal). In the present example according to FIG. 2, a first service is the CPNS and a second service is a UPnP network service. However, the UPnP second service according to this is example is non-limiting and other second services may be used in accordance with embodiments of the present invention.

Referring to FIG. 2, the PNGW 20 is capable of accessing the CPNS server 30 in an external network (i.e., a service provider network). In addition, the PNGW 20 configures a PN with the first service terminal 10 and relays a message and a service/content between the CPNS server 30 and the first service terminal 10. Specifically, upon receiving a service request from the first service terminal 10 being a PNE that has configured a PN with the PNGW 20, the PNGW 20 relays the service request to the CPNS server 20. Upon receiving the requested service from the service/content provider 40, the PNGW 20 transmits the service to the first terminal 10.

Herein, configuring a PN refers to identifying the roles of physically paired devices and building a network between a PNE and a GW so that the PNE may receive a CPNS. For this purpose, a determination is made as to whether the CPNS is supported between the first service terminal 10 and the PNGW 20 and as to whether the devices are CPNS-enabled through authentication and authorization, and the roles of the devices are identified (i.e., a determination is made as to whether the devices operate in GW mode or PNE mode). Through this series of processes, a network is established to provide the CPNS at an application level. The first service terminal 10 may access the CPNS server 30 of the service provider network by communicating with the PNGW 20 through the established PN.

According to an embodiment of the present invention, the PNGW 20 provides a service or content received from the CPNS server 30 to the second service terminal 60 as well as the first service terminal 10. More specifically, upon receipt of a request for an available CPNS service from the second service terminal 60, the PNGW 20 provides the available service or content to the second service terminal 60 in response to the request. In this manner, the PNGW 20 configures a PN with the first service terminal 10 and relays a CPNS system message and a service or content between the CPNS server 30 and the first service terminal 10, as well as between the first and second service terminals 10 and 60. The PNGW 20 may be, for example, a mobile phone, a Personal Digital Assistant (PDA), a set-top box, etc.

Upon receiving a registration request from the PNGW 20, the CPNS server 30 registers and manages the PNGW 20, the first service terminal 10, and the PN. The CPNS server 30 also processes a service and content request received from the first service terminal 10 through the PNGW 20. If the requested service or content is available, the CPNS server 30 provides the service or content to the first service terminal 10 through the PNGW 20. However, if the requested service or content is not available, the CPNS server 30 transmits the request to the external service/content provider 40 so that the service/content provider 40 may provide the service or content to the first service terminal 10 through the PNGW 20.

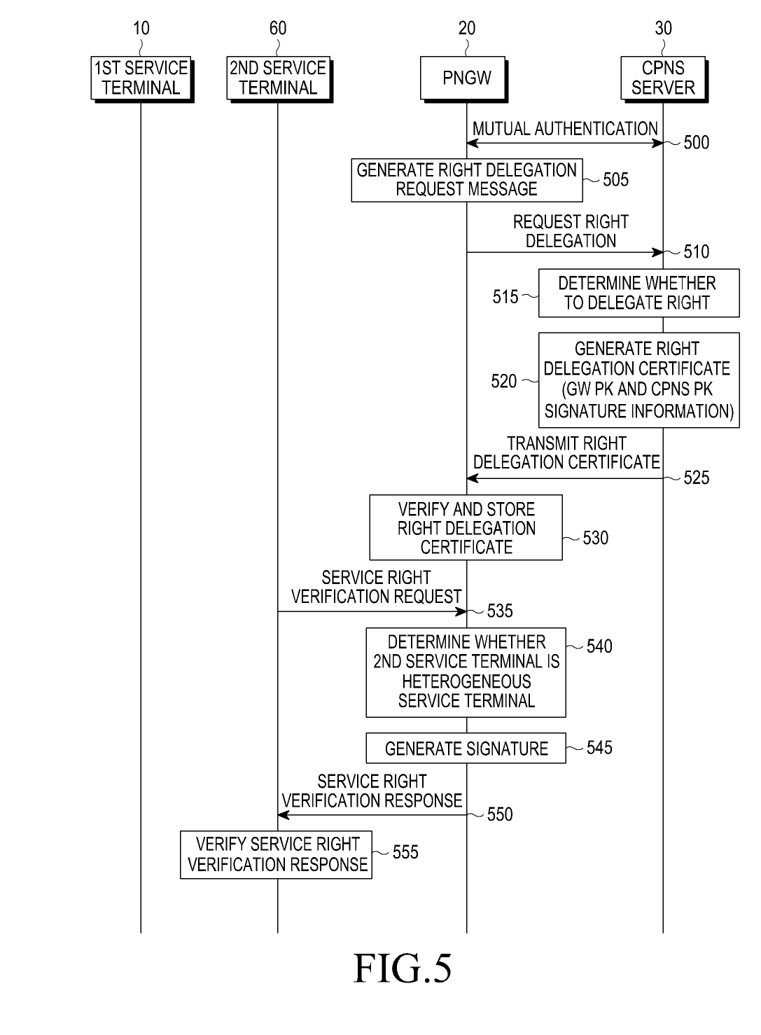

According to an embodiment of the present invention, the CPNS server 30 may receive a service or content request from the second service terminal 60 supporting a service other than the service of the first service terminal 10 through the PNGW 20. Before providing a service in response to the service or content request of the second service terminal 60, the CPNS server 30 delegates a right to the PNGW 20. According to the right delegation, the PNGW 20 authenticates and manages the second service terminal 60 on behalf of the CPNS server 30. If the authentication is successful, the second service terminal 60 may access the CPNS server 30 through the PNGW 20, to thereby receive the CPNS. A detailed description of a right delegation process will be given later with reference to FIG. 5.

Since CDs can be authenticated in an integrated manner for the UPnP network service and the CPNS, a CD supporting the UPnP network service can also receive the CPNS according to embodiments of the present invention.

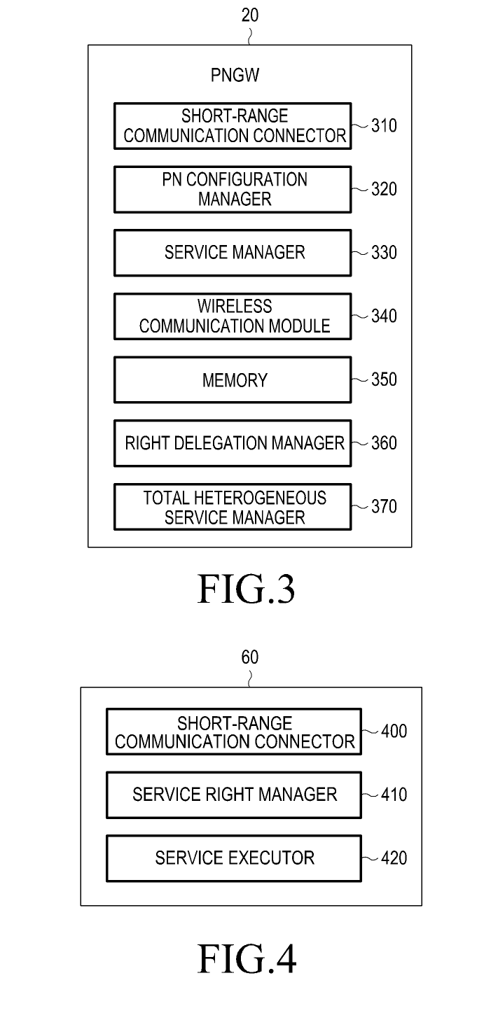

FIG. 3 is a block diagram illustrating a Personal Network GateWay (PNGW) according to an embodiment of the present invention

Referring to FIG. 3, the PNGW 20 includes a short-range communication connector 310 for establishing a physical connection with the first service terminal 10 through short-range communication, a PN configuration manager 320 for configuring a PN upon receipt of a PN connection request from the first service terminal 10, a service manager 330 for receiving a service requested by the first service terminal 10 from the CPNS server 30 or the service/content provider 40 and transmits the received service to the first service terminal 10, a wireless access module 340 for conducting communication with an external network (i.e., the CPNS server 30 or the service/content provider 40), and a memory 350 for storing information about a service terminal with which the PNGW 20 has configured a PN.

According to an embodiment of the present invention, the PNGW 20 is also connected to the second service terminal 60 through short-range communication. The PNGW 20 further includes a total heterogeneous service manager, which functions as a control point to provide a service other than the CPNS, including authentication and management of the second service terminal 60, and a right delegation manager 360 for taking over a right from the CPNS server 30. The total heterogeneous service manager 370 includes a conventional part functioning as a control point rather than a newly defined part and thus will not be described herein in detail. For example, the total heterogeneous service manager 370 corresponds to a part that performs the original functionality of a CP in a UPnP network. Thus, as the PNGW 20 includes components required to operate as a PNGW for the CPNS and components corresponding to a control point as well, the PNGW 20 may serve as a proxy.

The right delegation manager 360 sends, to the CPNS server 30, a right delegation request for authenticating the second service terminal 60, and receives a right delegation certificate from the CPNS server 30 in response to the right delegation request. The right delegation manager 360 may receive the right delegation certificate in advance after mutual authentication with the CPNS server 30 is performed and may store the received delegation certificate, or may receive the right delegation certificate by requesting right delegation to the CPNS server 30 after receiving a service right verification request from the second service terminal 60. Therefore, the PNGW 20 may authenticate and manage the second service terminal 60 and integrally manage the first and second service terminals 10 and 60 even though the first and second service terminals 10 and 60 support heterogeneous services.

FIG. 4 is a block diagram illustrating a service terminal according to an embodiment of the present invention.

A configuration of the second service terminal 60 is described as follows with reference to FIG. 4. Considering that the first and second service terminals 10 and 60 have similar configurations, the following description of the configuration second service terminal 60 may also be applied to first service terminal 10, in accordance with embodiments of the present invention.

Referring to FIG. 4, the second service terminal 60 includes a short-range communication connector 400 for establishing a physical connection through short-range communication with the PNGW 20 and another PNE, a service right manager 410 for transmitting a service right verification request to the PNGW 20 and receiving a service right verification response from the PNGW 20 in response to the service right verification request, and a service executor 420 for executing a service/content received from the PNGW 20.

FIG. 5 is a diagram illustrating a signal flow for an operation for delegating a right to a PNGW according to an embodiment of the present invention.

Referring to FIG. 5, the CPNS server 30 performs mutual authentication with the PNGW 20 in step 500. The mutual authentication process involves generating a pair of keys including a GW Secrete Key (GW SK) and a GW Public Key (GW PK) for used in mutual authentication by a key generation algorithm in the PNGW 20 and exchange of PKs between the PNGW 20 and the CPNS server 30.

Subsequently, the PNGW 20 may send, to the CPSN server 30, a request to delegate the right to authenticate the second service terminal 60 as well as the first service terminal 10 to the PNGW 20, in order to provide the CPNS and a service other than the CPNS. For this purpose, the PNGW 20 generates a right delegation request message in step 505 and transmits the right delegation request message to the CPNS server 30 in step 510.

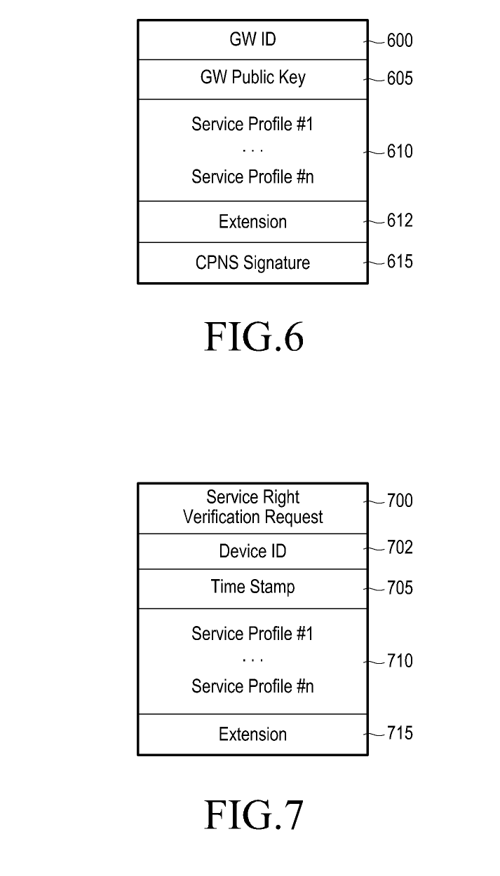

Upon receiving the right delegation request message, the CPNS server 30 determines whether to delegate the right according to a service provider policy in step 515. If the CPNS server 30 determines to delegate the right to the PNGW 20, the CPNS server 30 generates a right delegation certificate in step 520 and transmits the right delegation certificate to the PNGW 20 in step 525. FIG. 6 illustrates an example of a right delegation certificate, which may take the form of an X.509 certificate, according to an embodiment of the present invention.

FIG. 6 is a diagram illustrating a right delegation certificate according to an embodiment of the present invention.

Referring to FIG. 6, a GW Identifier (ID) 600 identifies a PNGW that has generated the right delegation request message. A GW PK 605 is a PK in a pair of keys generated for mutual authentication between the CPNS server 30 and the PNGW 20. Service Profiles 610 indicate CPNS services for which right delegation is allowed. The number of Service Profiles, ranging from 0 to n, may be determined according to a service provider policy. A CPNS Signature 615 is a signature signed for the right delegation certificate, using a private key of a CPNS right issuer. Herein, the private key is issued by a Certificate Authority (CA). The CPNS server 30 may store the private key or send a request for the private key to the CA when needed. An Extension 612 is a reserved field for information to be additionally included in the right delegation certificate, such as information about a right delegation duration, the maximum number of terminals to be serviced simultaneously, etc., in addition to the above-described fields.

Upon receiving the right delegation certificate as illustrated in FIG. 6, the PNGW 20 verifies and stores the received right delegation certificate in step 530. Specifically, the PNGW 20 verifies the CPNS Signature 615 of the right delegation certificate using its root certificate. If the CPNS Signature 615 is valid, the PNGW 20 stores and manages the right delegation certificate. However, if the CPNS Signature 615 is invalid, the PNGW 20 cannot use the received right delegation certificate. In this case, the PNGW 20 may send another request for a new right delegation certificate to the CPNS server 30.

Subsequently, the second service terminal 60 transmits a service right verification request message to the PNGW 20 to determine whether the PNGW 20 is authorized to provide the CPNS in step 535.

Upon receiving the service right verification request message, the PNGW 20 determines whether the second service terminal 60 is a heterogeneous service terminal using information included in the service right verification request message in step 540. In other words, the PNGW 20 determines whether the second service terminal 60 supports the same service as or a different service from the first service terminal 10.

If the second service terminal 60 is a heterogeneous service terminal, the PNGW generates a signature using the stored right delegation certificate in step 545. Alternatively or in addition to generating the signature, if the right delegation certificate has not been stored, the PNGW 20 may generate a right delegation request message for requesting authentication of the second service terminal 60 and receive the right delegation certificate as performed in steps 510 to 530. If the signature of the right issuer is not valid and thus the received right delegation certificate cannot be used, the PNGW 20 may transmit, to the second service terminal 60, a service right verification response message indicating that the PNGW 20 is not empowered to provide the CPNS to the second service terminal 60.

Upon receiving the service right verification request message, the PNGW 20 generates a signature to be included in a service right verification response message. The signature includes object information to be signed with the GW SK for mutual authentication. FIG. 7 illustrates an example signature object information. The signature may be expressed as Equation (1):

Signature=Sign(GW_{—}SK, object information) (1)

FIG. 7 is a diagram illustrating an example of signature object information according to an embodiment of the present invention.

Referring to FIG. 7, a Service Right Verification Request 700 in the signature object information of Equation (1) is included in a service right verification response message so that the service terminal 600 identifies that this is a service right verification response message for the service right verification request message transmitted by the second service terminal 60. A Device ID 702 identifies a service terminal that has transmitted the service right verification request message.

A Time Stamp 705 specifies a time that has arbitrarily been generated or transmitted by the second service terminal 60. In addition, Service Profiles 610 are included in the service right verification response message, specifying CPNS services set in the right delegation certificate. An Extension 715 is a reserved field for including information needed for authentication between the second service terminal 60 and the PNGW 20.

When the PNGW 20 generates the signature as described above, the PNGW transmits, to the second service terminal 60, a service right verification response message including the signature generated in step 545 and the right delegation certificate received in step 530, in step 550.

Upon receipt of the service right verification response message, the second service terminal 60 verifies the right delegation certificate and the signature in step 555. More specifically, the second service terminal 60 verifies the right delegation certificate and the signature in the manner expressed as Equation (2):

Verify(GW_{—}PK, Signature)=pass or fail (2)

Referring to Equation (2), the second service terminal 60 determines whether the signature is passed or failed by verifying the signature using the GW PK. Upon a determination that the signature is valid, the second service terminal 20 stores the received signature and right delegation certificate.

As described above, the PNGW 20 may authenticate the second service terminal 60 and the second service terminal 60 may receive the same service as the first service terminal 10.

As is apparent from the above description, according to embodiments of the present invention, a service can be provided to heterogeneous service terminals without modifying a security framework.

While the present invention have been shown and described with reference to particular embodiments thereof, it will be understood by those of ordinary skill in the art that various changes in form and details may be made therein without departing from the spirit and scope of the present invention as defined by the following claims.

What is claimed is:

1. A method for providing a service to heterogeneous service terminals performed by a Gateway (GW), the method comprising:
receiving a service right verification request from a first service terminal through short-range communication;
determining whether the first service terminal is a heterogeneous service terminal supporting a different service from a service provided to a second service terminal;
determining whether a right delegation certificate has been received from a Converged Personal Network Service (CPNS) server, which delegates a right for the first service terminal, if the first service terminal is determined to be a heterogeneous service terminal; and
transmitting a service right verification response including the right delegation certificate to the first service terminal.

2. The method of claim 1, wherein the right delegation certificate includes at least one of an Identifier (ID) of the GW, a public key for mutual authentication between the GW and the CPNS server, at least one service profile indicating a service for which right delegation is allowed, and a signature signed with a private key issued by a Certificate Authority (CA).

3. The method of claim 1, further comprising:
transmitting a right delegation request message to the CPNS server; and
receiving the right delegation certificate in response to the right delegation request message from the CPNS server.

4. The method of claim 3, further comprising:
verifying a signature of the right delegation certificate upon receiving the right delegation certificate; and
storing the right delegation certificate if the signature is verified as a valid signature.

5. The method of claim 3, wherein the right delegation request message transmits to the CPNS server before receiving the service right verification request from the first service terminal or upon receiving the service right verification request from the first service terminal.

6. The method of claim 1, wherein the service right verification response includes the right delegation certificate and a signature generated by the GW.

7. The method of claim 1, wherein the signature generated by the GW includes signature object information signed using a secret key for mutual authentication with the CPNS server, the signature object information including at least one of the service right verification request, a time stamp, an ID of a service terminal that transmitted the service right verification request, and at least one service profile indicating a service for which right delegation is allowed.

8. The method of claim 1, wherein the first service terminal verifies the signature generated by the GW using a public key and if the signature generated by the GW is verified as a valid signature, the first service terminal stores the signature generated by the GW and the right delegation certificate.

9. A method for receiving a service from a server through a Gateway (GW) performed by a service terminal, the method comprising:
transmitting a service right verification request to the GW through short-range communication;
receiving from the GW a service right verification response including a right delegation certificate and a signature generated by the GW, when the GW receives from the server the right delegation certificate that delegates a right for the service terminal to the GW in response to the service right verification request;
verifying the received signature; and
storing the received signature and the right delegation certificate, if the signature is verified as a valid signature.

10. The method of claim 9, wherein the right delegation certificate includes at least one of an IDentifier (ID) of the GW, a public key for mutual authentication between the GW and the server, at least one service profile indicating a service for which right delegation is allowed, and a signature signed with a private key issued by a Certificate Authority (CA).

11. The method of claim 9, wherein the service terminal supports a service other than a Converged Personal Network Service (CPNS) provided through the GW by the server.

12. The method of claim 9, wherein the signature generated by the GW includes signature object information signed using a secret key for mutual authentication with the server, the signature object information including at least one of the service right verification request, a time stamp, an ID of a service terminal that transmitted the service right verification request, and at least one service profile indicating a service for which right delegation is allowed.

13. A Gateway (GW) device for providing a service to heterogeneous service terminals, the gateway comprising:
a short-range communication connector for establishing a physical connection with a first service terminal through short-range communication;
a Personal Network (PN) configuration manager for configuring a PN upon receiving a PN connection request from the first service terminal;
a service manager for receiving a service requested by the first service terminal from a Converged Personal Network Service (CPNS) server and transmitting the received service;
a wireless access module for communicating with the CPNS server;
a memory for storing information a service terminal with which the gateway has configured a PN; and
a right delegation manager for, upon receiving a service right verification request from a second service terminal through the short-range communication connector, determining whether the second service terminal is a heterogeneous service terminal supporting a different service from the service provided to the first service terminal, determining whether there is a right delegation certificate received from the server, which delegates a right for the second service terminal if the second service terminal is a heterogeneous service terminal, and transmitting a service right verification response including the delegated right delegation certificate to the second service terminal.

14. The gateway device of claim 13, wherein the right delegation certificate includes at least one of an IDentifier (ID) of the GW, a public key for mutual authentication between the GW and the server, at least one service profile indicating a service for which right delegation is allowed, and a signature signed with a private key issued by a Certificate Authority (CA).

15. The gateway device of claim 13, wherein the right delegation manager transmits a right delegation request message to the server before receiving the service right verification request from the second service terminal or upon receiving the service right verification request from the second service terminal, and receives the right delegation certificate in response to the right delegation request message from the server.

16. The gateway device of claim 15, wherein upon receiving the right delegation certificate, the right delegation manager verifies a signature of the right delegation certificate and if the signature is verified as a valid signature, the right delegation manager stores the right delegation certificate in the memory.

17. The gateway device of claim 15, wherein the service right verification response includes the right delegation certificate and a signature generated by the gateway.

18. The gateway device of claim 17, wherein the signature generated by the gateway includes signature object information signed using a secret key for mutual authentication with the server, the signature object information including at least one of the service right verification request, a time stamp, an IDentifier (ID) of a service terminal that transmitted the service right verification request, and at least one service profile indicating a service for which right delegation is allowed.

19. The gateway device of claim 18, wherein the second service terminal verifies the signature generated by the gateway using a public key, and
wherein if the signature generated by the gateway is verified as a valid signature, the second service terminal stores the signature generated by the gateway and the right delegation certificate.
